(19) United States
(12) Patent Application Publication
(10) Pub. No.: US 2002/0132044 A1
(43) Pub. Date: Sep. 19, 2002

(54) Scratch repair procedure

(76) Inventor: James H. Quarles, Ringgold, GA (US)

Correspondence Address: BASF CORPORATION, ANNE GERRY SABOURIN, 26701 TELEGRAPH ROAD, SOUTHFIELD, MI, 48034-2442, US

(21) Appl. No.: 09/811,794

(22) Filed: Mar. 19, 2001

(51) Int. Cl. B05D 3/02; B05D 1/36

(52) U.S. Cl. 427/140; 427/407.1; 427/385.5

(57) ABSTRACT

A method for repairing a defect, such as a scratch, in a clear coat layer of a composite color-plus-clear coating system is described. First, a sufficient amount of catalyzed transparent coating composition is directed through a cylindrical tube attached to a container for the coating, into the scratch so as to cause a portion of the catalyzed transparent coating composition to overfill the volume of the scratch. The catalyzed transparent coating composition is then allowed to cure, whereupon the excess above the uppermost surface of the clear coat layer is then lightly sanded away to produce a substantially planar surface. The area can then be optionally polished. In this manner, scratches in the clear coat layer of composite color-plus-clear coating systems can be repaired while simultaneously restoring the original thickness of the clear coat layer.

### FIELD OF THE INVENTION

The present invention relates generally to composite color-plus-clear automobile finishes, and more particularly to methods for the simple and inexpensive repair of a scratch in a layer of clear coat to produce an aesthetically pleasing result while simultaneously restoring the original thickness of the clear coat layer.

### BACKGROUND OF THE INVENTION

The paint systems used on modern automobiles differ significantly from predecessor paint systems that were used on older automobiles, both in terms of structure and in the care they require. Generally speaking, the finish layer on most cars of the past was a pigmented, oil-based paint. When cleaning or polishing these conventional finishes, the layer of paint that gives an automobile it's color is being worked directly. Conversely, the modern automobile finish is typically, although not always, a water-based paint system which has a clear top layer for providing a highly glossy, yet protective, surface. These modern paint systems are popularly known as composite color-plus-clear finishes.

A composite color-plus-clear coating is generally defined as any paint system that has a pigmented layer protected by a clear transparent final coating. Although the chemical compound and application technology is rapidly changing, most composite color-plus-clear coating systems may be defined as follows. A composite color-plus-clear coating system generally consists of a pigmented coating layer and a clear coat layer. The total film thickness of modern composite systems is typically thin (i.e., about 3.5 to 5.5 mils thick), with the clear coat layer being about 2.0 to 2.5 mils thick.

Although composite color-plus-clear finishes have greatly enhanced the protection of automobile surfaces from corrosion, it is still possible for scratches to occur in the clear coat layer 16 itself. Normally, these scratches are minor and barely visible. However, sometimes a scratch 20 is relatively deep and clearly noticeable, as shown in FIG. 2. In order to remove or lessen the appearance of these deeper scratches, consumers, and even automobile body repair specialists, typically use an abrasive (e.g., very fine grit sandpaper) followed with a non-abrasive polishing agent. Although this procedure may remove the scratch 20 to produce an aesthetically pleasing result, it also has the unintended effect of removing a significant amount (e.g., depth-wise) of clear coat material at the “repaired” scratch site 30, as shown in FIG. 3. It is generally recognized in the automotive industry that removal of as little as 0.3 mil of the clear coat layer 16 can lead to premature failure of the underlying pigmented coating layer 14. This is due, in part, to a decrease in the amount of UV protection at the failure site due to the relative thinning of the clear coat layer 16. Ultimately, failure of the underlying pigmented coating layer 14 will necessitate the expensive and time-consuming refinishing of the entire affected surface area.

One approach to repairing and restoring chipped and scratched regions of an exterior paint finish of an automotive body is described in U.S. Pat. No. 5,834,054 to Berry. When the damage is characterized by recesses in the exterior, the approach involves the use of color-matched paint repair material, and includes the steps of cleaning the recesses, and coating the recesses and adjacent area with a lubricating agent that also will retard the ability of the repair material to bond with surfaces of the damaged region. The paint-repair material is then deposited on undamaged surfaces adjacent the recesses, and then a blade comprised of a soft resilient plastic material is slidably moved over the damaged region to spread and move the deposited paint over the damaged region causing the paint-material to be deposited in the recesses and to remove most of the excess material from the undamaged surfaces adjacent to the recesses. After a short drying interval, final steps include wiping away excess repair material with a soft cloth wetted with a suitable solvent.

Although the approach described by Berry is somewhat helpful in repairing and restoring chipped and scratched regions of an exterior paint finish of an automotive body, it suffers from several disadvantages when evaluating it's efficacy for repairing defects in a clear coat layer. First, the use of lubricating agents represents an added material cost and the agents may adversely affect the clear coat material (e.g., adhesion, curing time, and so forth) that is to be deposited into the defect. Second, the use of a knife-like object to spread and move the material into the defect presumes that the defect is fairly shallow. For example, if a relatively deep defect is present, it is likely that the clear coat material may not fully penetrate into the recess therein, thus compromising the integrity of the supposedly “repaired” area.

Therefore, there exists a need for a method for the simple and inexpensive repair of a scratch in a layer of clear coat to produce an aesthetically pleasing result while simultaneously restoring the original thickness of the clear coat layer at the scratch site.

### SUMMARY OF THE INVENTION

In accordance with one embodiment of the present invention, a method of repairing a defect in the uppermost surface of a cured composite color-plus-clear coating system is provided, the method comprising: (1) directing into the defect an amount of a catalyzed transparent coating composition such that a portion of the directed catalyzed transparent coating composition extends above the uppermost surface of the transparent coating layer; (2) curing the directed amount of catalyzed transparent coating composition; and (3) removing that portion of the cured catalyzed transparent coating which extends above the surface of the transparent coating layer.

In accordance with another embodiment of the present invention, a method of repairing a defect in the uppermost surface of a cured composite color-plus-clear coating system is provided, the method comprising: (1) directing into the defect an amount of a catalyzed transparent coating composition such that a portion of the directed catalyzed transparent coating composition extends above the uppermost surface of the transparent coating layer; (2) curing the directed amount of catalyzed transparent coating composition; and (3) removing that portion of the cured catalyzed transparent coating which extends above the surface of the transparent coating layer; wherein the amount of catalyzed transparent coating composition is directed into the defect using a hollow, substantially cylindrical tube attached to a container for the catalyzed transparent coating composition.

In accordance with still another embodiment of the present invention, a method of repairing a defect in the uppermost surface of a cured composite color-plus-clear coating system is provided, the method comprising: (1) directing into the defect an amount of a catalyzed transparent coating composition such that a portion of the directed catalyzed transparent coating composition extends above the uppermost surface of the transparent coating layer; (2) curing the directed amount of catalyzed transparent coating composition; and (3) removing that portion of the cured catalyzed transparent coating which extends above the surface of the transparent coating layer; wherein the amount of catalyzed transparent coating composition is directed into the defect using a hollow, substantially cylindrical tube attached to a container for the catalyzed transparent coating composition; wherein the directed catalyzed transparent coating composition extends substantially hemispherically above the defect and beyond the uppermost surface of the transparent coating layer; wherein the directed amount of the catalyzed transparent coating composition occupies a volume which is greater than the volume of the defect but which is no more than about 3 times the volume of the defect.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description and the accompanying drawings, wherein:

FIG. 1 is a sectional view of a clear coat system, in accordance with the prior art;

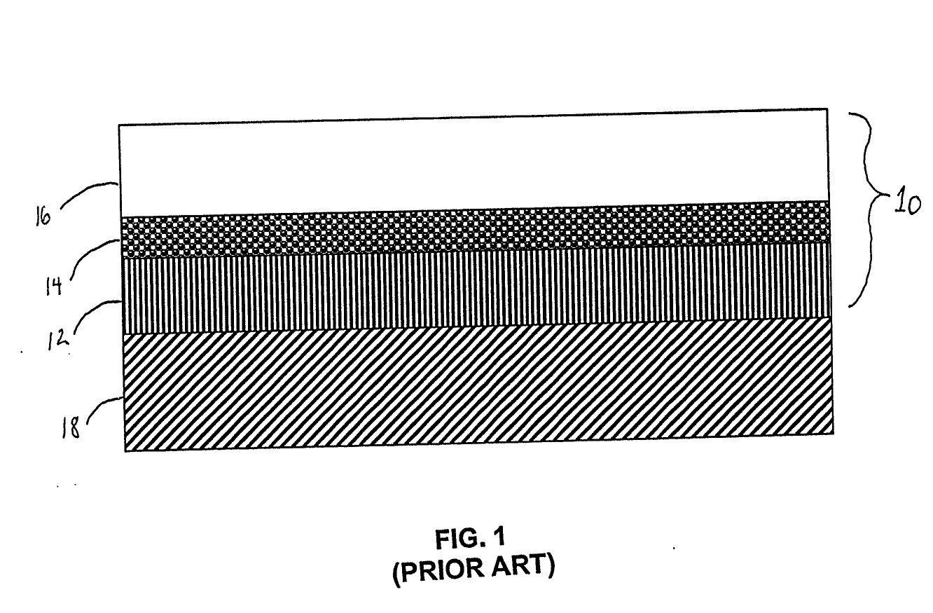

FIG. 2 is a sectional view of a clear coat system having a scratch in the clear coat layer, in accordance with the prior art;

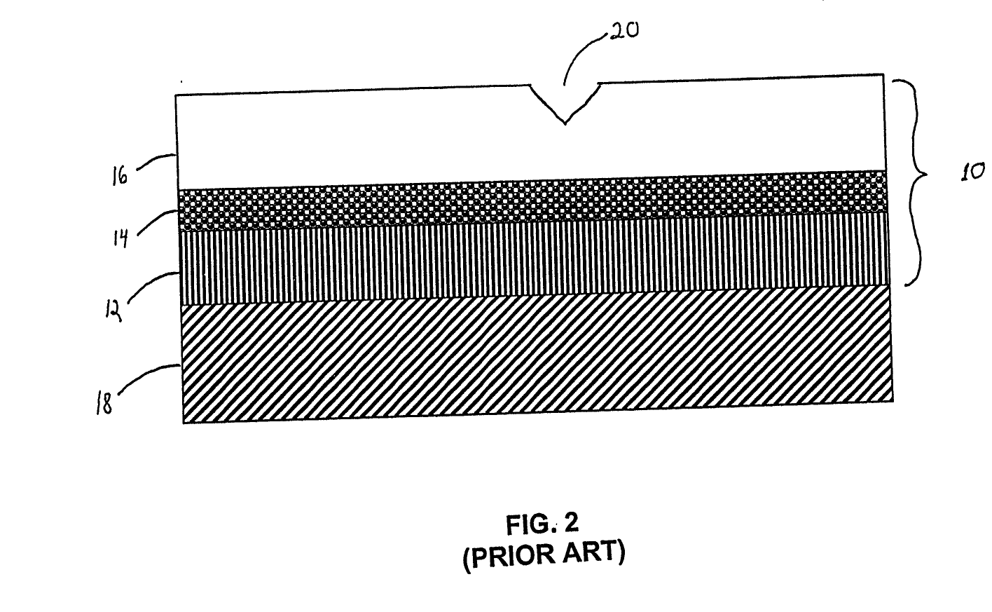

FIG. 3 is a sectional view of a clear coat system having a repaired scratch in the clear coat layer, in accordance with the prior art;

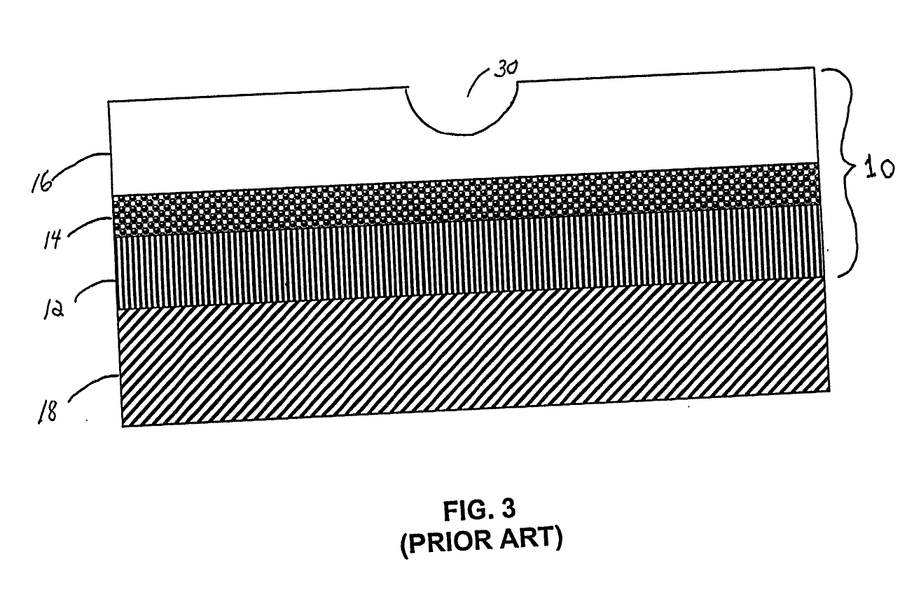

FIG. 4 is a perspective view of a curable, liquid clear coat material being introduced into a scratch in the clear coat layer of a clear coat system, in accordance with the general teachings of the present invention;

FIG. 5 is a partial enlarged sectional view of a curable, liquid clear coat material disposed within a scratch in the clear coat layer of a clear coat system, in accordance with the general teachings of the present invention; and

FIG. 6 is a partial enlarged sectional view of a repaired scratch site of a clear coat layer of a clear coat system, in accordance with the general teachings of the present invention.

The same reference numerals refer to the same parts throughout the various Figures.

### DETAILED DESCRIPTION OF THE PREFERRED EMBODIMENTS

The present invention will now be described with particular emphasis on the repair of scratches in the clear coat layer of an automobile composite color-plus-clear finish. However, it should be appreciated that the present invention is equally applicable to the repair of a scratch in any type of composite color-plus-clear. regardless of the type of vehicle or surface it is applied to.

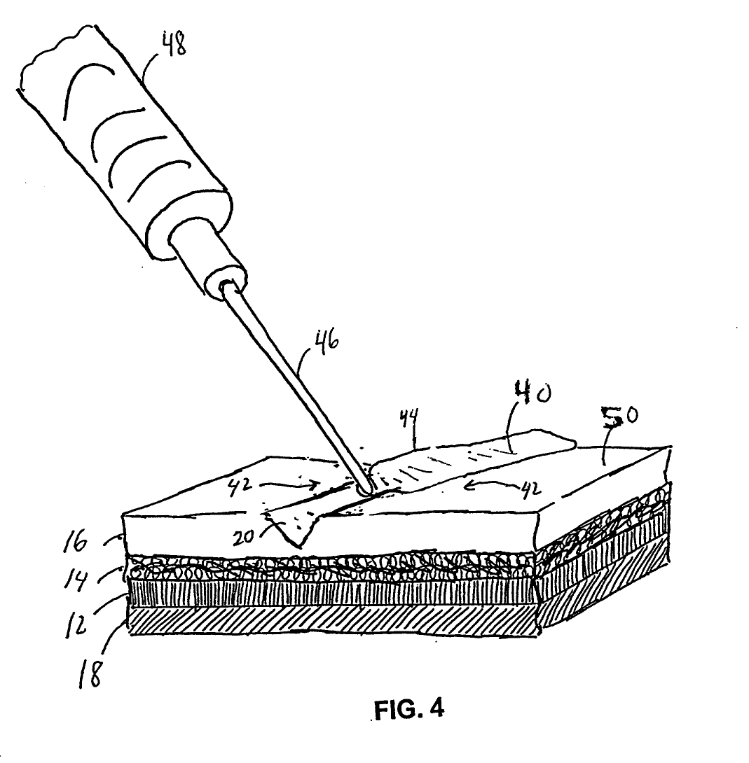

Referring generally to FIGS. 4-6, a sufficient amount of a catalyzed transparent coating composition 40 is directed into the volume of scratch 20 so as to permit some of this catalyzed transparent coating composition 40 to overfill the volume of scratch 20. It is permissible to allow a portion of this catalyzed transparent coating composition 40 to cover at least a portion of the adjacent areas 42 surrounding the scratch 20. It is preferred that the catalyzed transparent coating composition 40 is chemically and/or physically compatible with the pre-existing material comprising clear coat layer 16.

The precise amount of the directed amount of the catalyzed transparent coating composition 40 is not thought to be critical to the success of the present invention. However, in accordance with a preferred embodiment of the present invention, the directed amount of the catalyzed transparent coating composition 40 occupies a volume which is greater than the volume of the scratch 20 but which is no more than about 3 times the volume of the scratch 20. In accordance with another preferred embodiment of the present invention, the directed amount of the catalyzed transparent coating composition occupies a volume which is greater than the volume of the defect but which is no more than about 2.5 times the volume of the defect. In accordance with still another preferred embodiment of the present invention, the directed amount of the catalyzed transparent coating composition occupies a volume which is greater than the volume of the defect but which is no more than about 2 times the volume of the defect. In accordance with still yet another preferred embodiment of the present invention, the directed amount of the catalyzed transparent coating composition occupies a volume which is greater than the volume of the defect but which is no more than about 1.5 times the volume of the defect. In accordance with a further preferred embodiment of the present invention, the directed amount of the catalyzed transparent coating composition occupies a volume which is greater than the volume of the defect but which is no more than about 1.5 to about 3 times the volume of the defect.

Once applied, the catalyzed transparent coating composition 40 preferably forms a substantially hemispherical shape 44, covering the entire scratch 20. Optionally, some of the catalyzed transparent coating composition 40 may cover a portion of the adjacent areas 42 surrounding the scratch 20.

It is preferred to direct the catalyzed transparent coating composition 40 into the volume of scratch 20 with, for example, a hypodermic needle 46 in conjunction with a syringe 48 containing an amount of the catalyzed transparent coating composition 40, or other suitable device, which allows for the careful and controlled deposition of the material 40. Without being bound to a particular theory of the operation of the present invention, it is believed that because it is difficult to place the material 40 into the volume of scratch 20, bulky devices, such as caulk guns or spackling knives, would be unable to penetrate into the volume of scratch 20, and therefore, more delicate instrumentation is preferred. Therefore, hypodermic needles of various sizes may be employed, depending on the depth and width of the particular scratch to be repaired. For instance, a relatively large gauge needle may be employed for scratches having a wide and/or shallow volume. Conversely, a relatively small gauge needle may be employed for scratches having a narrow and/or deep volume.

The catalyzed transparent coating composition 40 is typically comprised of a specific ratio mixture of a “clear” component which is typically a transparent polymer material, such as, but not limited to polyurethane, and a “hardener” component which is typically an agent that permits the mixture to harden as it cures. The curing can take place by number of ways, such as by exposing the mixture to air, heat, UV or IR radiation, and the like. Suitable clear coat components are readily commercially available from many different manufacturers. In accordance with a preferred embodiment of the present invention, the clear component is DC-COP and the hardener component is DH42, both of which are manufactured by BASF Corporation (Mount Olive, N.J.). DC-COP is an acrylic resin containing cross-linkable hydroxy groups, together with various solvents, UV absorbers, and additives for flow and levelling control. Being a clear coat, DC-COP generally does not contain pigments, however it is sometimes desirable to include an effect pigment such as mica or a metallic pigment, or even small amounts of a color pigment. DH42 is a liquid polyisocyanate hardener combined with various solvents and other additives. It reacts with the hydroxy-functional acrylic resin to form an acrylic urethane coating. Regardless of the choice of clear and/or hardener components used, the components should be physically and/or chemically compatible with the pre-existing material comprising clear coat layer 16, as previously noted.

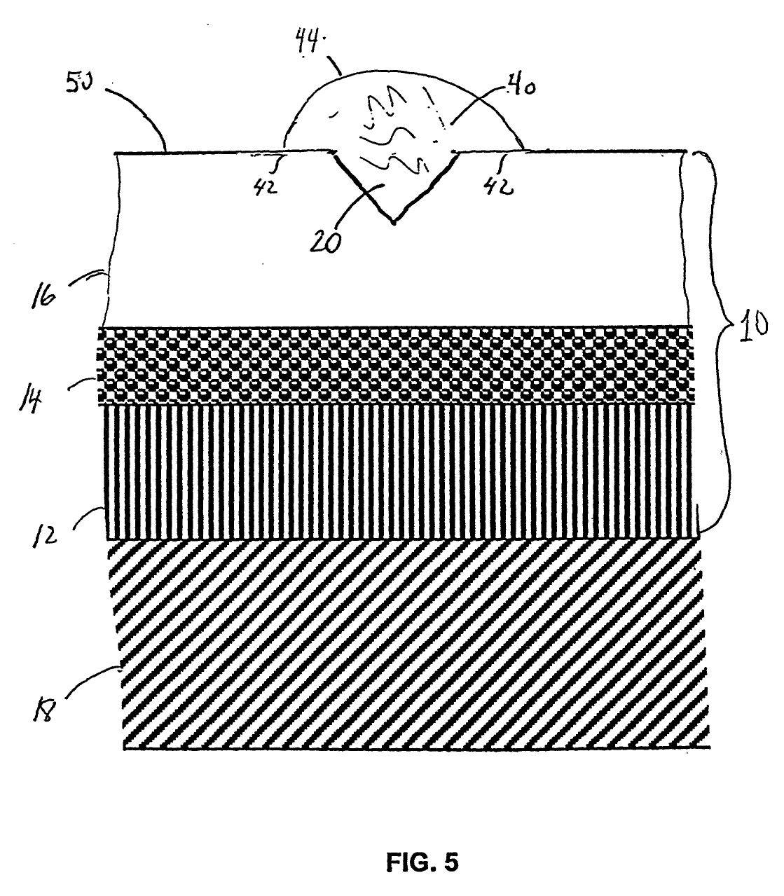

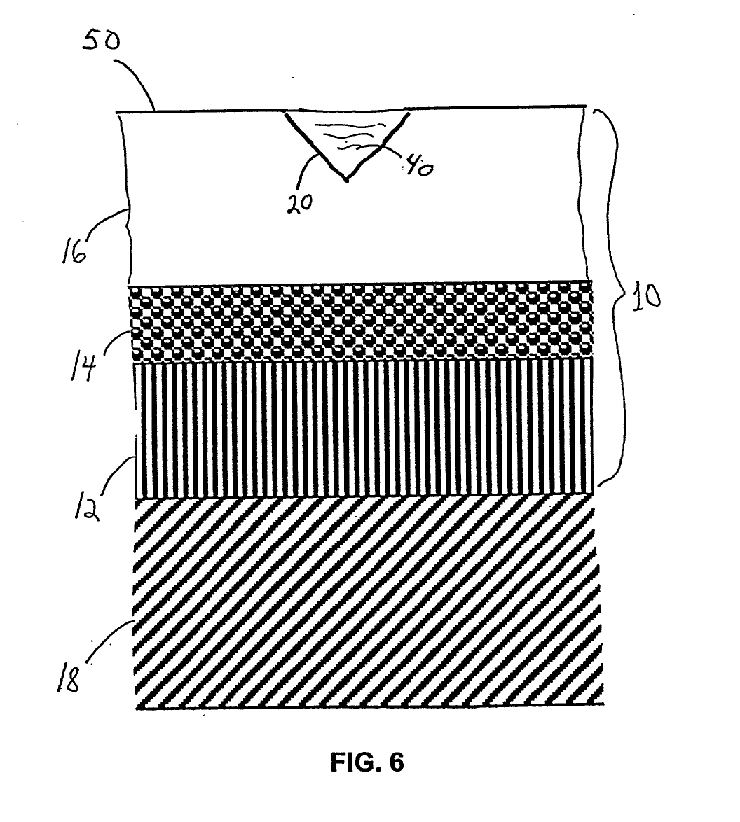

Once the catalyzed transparent coating composition 40 has been applied, it is then allowed to cure. Referring to FIG. 6, once curing has occurred, the excess amount of cured catalyzed transparent coating composition 40 (see FIG. 5) is then removed from the top surface 50 of the clear coat layer 16. By way of a non-limiting example, the excess amount of the cured catalyzed transparent coating composition 40 is lightly sanded (i.e., abraded) with an abrasive material, such as, for example, a sandpaper block. The sandpaper preferably has a grit rating in the range of about 1500 to about 2500, with about 1500 being highly preferred. This sanding procedure removes the excess amount of the cured catalyzed transparent coating composition 40 to produce a substantially planar (i.e., flat) surface. All that remains of the cured catalyzed transparent coating composition 40 is that portion filling the volume of the original scratch 20.

The scratch repair site may then be optionally polished with a suitable non-abrasive clear coat polish.

The present invention permits scratches in the clear coat layer to be simply and inexpensively repaired to produce an aesthetically pleasing result. More importantly, the present invention permits the clear coat layer at the scratch site to be augmented, as opposed to being depleted, as is the case with conventional sanding and polishing techniques. In fact, the present invention can restore the clear coat layer to it's original thickness at the scratch site. In this manner, the present invention preserves the UV protection function and effectiveness of the clear coat layer and aids in the prevention of UV-radiation induced pigmented coating layer failure.

The foregoing description is considered illustrative only of the principles of the invention. Furthermore, because numerous modifications and changes will readily occur to those skilled in the art, it is not desired to limit the invention to the exact construction and process shown as described above. Accordingly, all suitable modifications and equivalents that may be resorted to that fall within the scope of the invention as defined by the claims that follow.

1. A method of repairing a defect in the uppermost surface of a cured composite color-plus-clear coating system, the method comprising:
directing into the defect an amount of a catalyzed transparent coating composition such that a portion of the directed catalyzed transparent coating composition extends above the uppermost surface of the transparent coating layer;
curing the directed amount of catalyzed transparent coating composition; and
removing that portion of the cured catalyzed transparent coating which extends above the surface of the transparent coating layer.

2. The method of claim 1, wherein the directed amount of the catalyzed transparent coating composition occupies a volume which is greater than the volume of the defect but which is no more than about 3 times the volume of the defect.

3. The method of claim 1, wherein the directed amount of the catalyzed transparent coating composition occupies a volume which is greater than the volume of the defect but which is no more than about 2.5 times the volume of the defect.

4. The method of claim 1, wherein the directed amount of the catalyzed transparent coating composition occupies a volume which is greater than the volume of the defect but which is no more than about 2 times the volume of the defect.

5. The method of claim 1, wherein the directed amount of the catalyzed transparent coating composition occupies a volume which is greater than the volume of the defect but which is no more than about 1.5 times the volume of the defect.

6. The method of claim 1, wherein the directed amount of the catalyzed transparent coating composition occupies a volume which is greater than the volume of the defect but which is no more than about 1.5 to about 3 times the volume of the defect.

7. The method of claim 1, wherein the directed catalyzed transparent coating composition extends substantially hemispherically above the defect and beyond the uppermost surface of the transparent coating layer.

8. The method of claim 1, wherein the amount of catalyzed transparent coating composition is directed into the defect using a hollow, substantially cylindrical tube attached to a container for the catalyzed transparent coating composition.

9. The method of claim 8, wherein the diameter of the hollow, substantially cylindrical tube substantially corresponds to the diameter of the defect.

10. The method of claim 8, wherein the hollow, substantially cylindrical tube is a hollow needle.

11. The method of claim 10, wherein the hollow needle is a hypodermic needle.

12. The method of claim 8, wherein the container for the catalyzed transparent coating composition is a syringe.

13. The method of claim 1, wherein that portion of the cured catalyzed transparent coating which extends above the surface of the transparent coating layer is removed by abrasion.

14. A method of repairing a defect in the uppermost surface of a cured composite color-plus-clear coating system, the method comprising:
directing into the defect an amount of a catalyzed transparent coating composition such that a portion of the directed catalyzed transparent coating composition extends above the uppermost surface of the transparent coating layer;
curing the directed amount of catalyzed transparent coating composition; and
removing that portion of the cured catalyzed transparent coating which extends above the surface of the transparent coating layer;
wherein the amount of catalyzed transparent coating composition is directed into the defect using a hollow, substantially cylindrical tube attached to a container for the catalyzed transparent coating composition.

15. The method of claim 14, wherein the directed amount of the catalyzed transparent coating composition occupies a volume which is greater than the volume of the defect but which is no more than about 3 times the volume of the defect.

16. The method of claim 14, wherein the directed amount of the catalyzed transparent coating composition occupies a volume which is greater than the volume of the defect but which is no more than about 2.5 times the volume of the defect.

17. The method of claim 14, wherein the directed amount of the catalyzed transparent coating composition occupies a volume which is greater than the volume of the defect but which is no more than about 2 times the volume of the defect.

18. The method of claim 14, wherein the directed amount of the catalyzed transparent coating composition occupies a volume which is greater than the volume of the defect but which is no more than about 1.5 times the volume of the defect.

19. The method of claim 14, wherein the directed amount of the catalyzed transparent coating composition occupies a volume which is greater than the volume of the defect but which is no more than about 1.5 to about 3 times the volume of the defect.

20. The method of claim 14, wherein the directed catalyzed transparent coating composition extends substantially hemispherically above the defect and beyond the uppermost surface of the transparent coating layer.

21. The method of claim 14, wherein the hollow, substantially cylindrical tube is a hollow needle.

22. The method of claim 21, wherein the hollow needle is a hypodermic needle.

23. The method of claim 14, wherein the diameter of the hollow, substantially cylindrical tube substantially corresponds to the diameter of the defect.

24. The method of claim 14, wherein the container for the catalyzed transparent coating composition is a syringe.

25. The method of claim 14, wherein that portion of the cured catalyzed transparent coating which extends above the surface of the transparent coating layer is removed by abrasion.

26. A method of repairing a defect in the uppermost surface of a cured composite color-plus-clear coating system, the method comprising:
directing into the defect an amount of a catalyzed transparent coating composition such that a portion of the directed catalyzed transparent coating composition extends above the uppermost surface of the transparent coating layer;
curing the directed amount of catalyzed transparent coating composition; and
removing that portion of the cured catalyzed transparent coating which extends above the surface of the transparent coating layer;
wherein the amount of catalyzed transparent coating composition is directed into the defect using a hollow, substantially cylindrical tube attached to a container for the catalyzed transparent coating composition;
wherein the directed catalyzed transparent coating composition extends substantially hemispherically above the defect and beyond the uppermost surface of the transparent coating layer;
wherein the directed amount of the catalyzed transparent coating composition occupies a volume which is greater than the volume of the defect but which is no more than about 3 times the volume of the defect.

27. The method of claim 26, wherein the directed amount of the catalyzed transparent coating composition occupies a volume which is greater than the volume of the defect but which is no more than about 2.5 times the volume of the defect.

28. The method of claim 26, wherein the directed amount of the catalyzed transparent coating composition occupies a volume which is greater than the volume of the defect but which is no more than about 2 times the volume of the defect.

29. The method of claim 26, wherein the directed amount of the catalyzed transparent coating composition occupies a volume which is greater than the volume of the defect but which is no more than about 1.5 times the volume of the defect.

30. The method of claim 26, wherein the directed amount of the catalyzed transparent coating composition occupies a volume which is greater than the volume of the defect but which is no more than about 1.5 to about 3 times the volume of the defect.

31. The method of claim 26, wherein the hollow, substantially cylindrical tube is a hollow needle.

32. The method of claim 31, wherein the hollow needle is a hypodermic needle.

33. The method of claim 26, wherein the diameter of the hollow, substantially cylindrical tube substantially corresponds to the diameter of the defect.

34. The method of claim 26, wherein the container for the catalyzed transparent coating composition is a syringe.

35. The method of claim 26, wherein that portion of the cured catalyzed transparent coating which extends above the surface of the transparent coating layer is removed by abrasion.
